(19) United States
(12) Patent Application Publication
(10) Pub. No.: US 2008/0050291 A1
(43) Pub. Date: Feb. 28, 2008

(54) Plasma Generation Device

(75) Inventor: Takeshi Nagasawa, Tochigi (JP)

Correspondence Address: WALLENSTEIN & WAGNER, LTD., 311 SOUTH WACKER DRIVE, 53RD FLOOR, CHICAGO, IL, 60606, US

(73) Assignee: Yutaka Electronics Industry Co.,Ltd.

(21) Appl. No.: 10/565,602

(22) PCT Filed: Oct. 5, 2005
(86) PCT No.: PCT/JP05/18457

§ 371 Date: Mar. 16, 2007

(30) Foreign Application Priority Data
Oct. 18, 2004 (JP) 2004-303240

(51) Int. Cl. B01J 19/12

(52) U.S. Cl. 422/186.04

(57) ABSTRACT

A plasma generation device that can efficiently generate plasma at atmospheric pressure without producing arc discharge is provided. The plasma generation device, which comprises an electrode bar 1, a cylindrical electrode 2, and a pulse power supply 11 generating a pulse voltage, generates plasma by an electric discharge induced between the electrode bar 1 and cylindrical electrode 2 by applying a predetermined pulse voltage to a point between the electrode bar 1 and cylindrical electrode 2.

This is a U.S. national stage of PCT Application No. PCT/JP2005/018457 filed on Oct. 5, 2005, claiming priority from Japanese Patent Application No. 2004-303240 filed on Oct. 18, 2004.

### FIELD OF THE INVENTION

The present invention relates to a plasma generation device that generates plasma at atmospheric pressure rather than in a sealed vacuum or other pressure-controlled environment.

### BACKGROUND OF THE INVENTION

Recently, there are increasing needs to generate plasma at atmospheric pressure. The plasma may be used to modify the surface of an object, for example.

As one known example of an application of such surface modification, plasma can be used to roughen a polypropylene (hereinafter “PP”) surface before printing thereon, as the polypropylene surface is otherwise too smooth to hold ink.

Roughening the surface of an object also increases its adhesiveness when an adhesive is applied for bonding.

Use of an electric discharge to generate plasma is well known, as disclosed in Japanese published unexamined patent application No. 2001-68298 (hereinafter “JP-A-2001-68298”).

The invention described in JP-A-2001-68298 discloses a technique for generating plasma which consists in causing an arc discharge between a stud-shaped electrode and a casing (ground potential) surrounding the electrode, and blowing a working gas into the discharge path to generate a plasma of the working gas.

### SUMMARY OF THE INVENTION

In prior-art plasma generation devices, as in the invention described in JP-A-2001-68298, plasma is generated by decomposing a working gas using the heat generated by an arc discharge between electrodes.

Using the arc discharge for decomposing the working gas as in the prior art, however, involves several problems, including high voltage requirements, high power consumption, extra energy wasted for decomposing the working gas by heat, a high calorie generated for generating plasma, and fast dissolution of electrodes.

The present invention addresses the above problems by providing a plasma generation device capable of efficiently generating plasma at atmospheric pressure without generating an arc discharge.

The plasma generation device according to the present invention comprises a first electrode, a second electrode, and a pulse power supply for providing a pulse voltage, and generates plasma by an electric discharge induced between the first electrode and the second electrode when a predetermined pulse voltage from the pulse power supply is applied between the first electrode and the second electrode.

In an embodiment of the present invention, the first electrode is an electrode bar, the second electrode is a cylindrical electrode, and the electrode bar is disposed at the center of the cylindrical electrode, whereby coaxial cylindrical electrodes are formed.

In another embodiment of the present invention, the first electrode is an electrode bar, the second electrode is an electrode plate, and the electrode bar is disposed with one end facing the electrode plate, with a predetermined distance therebetween.

According to the present invention, a plasma generation device is provided which does not require an arc discharge and can efficiently generate plasma at atmospheric pressure as detailed below.

Specifically, less power is consumed because the working gas is decomposed without using the traditional arc discharge, which requires a large current. Further, since heat is not used for decomposing the working gas, extra energy is not wasted, a high calorie is not generated for generating plasma, and electrodes are not dissolved.

In addition, extra thermal energy is not wasted, because plasma is generated by decomposing the working gas by means of the electrons produced by a spark discharge, not by the traditional arc discharge.

Further, a discharge path for generating plasma can be formed even at a low discharge voltage, because the effect of electrical discharge is enhanced by the coaxial cylindrical electrodes.

Furthermore, less power is consumed because a pulse voltage is applied to electrodes, which causes a glow corona discharge or a spark discharge, instead of a continuous arc discharge.

In addition, substantially no heat is generated because the working gas is ionized and decomposed by collisions of electrons with the working gas.

Further, because a pulse voltage is applied to electrodes to cause a glow corona discharge or a spark discharge, instead of a continuous arc discharge, so less heat is generated and electrodes are not dissolved accordingly.

### BRIEF DESCRIPTION OF THE DRAWINGS

FIG. 1 is a sectional block diagram schematically showing the structure of a plasma generation device according to an embodiment of the present invention.

FIG. 2 illustrates the effects of coaxial cylindrical electrodes of the plasma generation device shown in FIG. 1.

FIG. 3 is a sectional block diagram schematically showing the structure of a plasma generation device according to another embodiment of the present invention.

FIG. 4 is a sectional block diagram schematically showing the structure of a plasma generation device according to still another embodiment of the present invention.

FIGS. 5A and 5B are bottom views of electrode bars of the plasma generation device in FIG. 3 wherein FIG. 5A shows five electrode bars disposed close to each other and FIG. 5B shows five electrode bars disposed apart from each other.

FIG. 6 shows an arrangement different from that of FIG. 5A, for addressing the inefficiency due to no electric discharge from the central electrode bar.

FIG. 7 shows another arrangement different from those in FIG. 5b and FIG. 6, for addressing the inefficiency due to no electric discharge from the central electrode bar.

FIG. 8 is a sectional block diagram schematically showing a multiple-type plasma generation apparatus comprising a plurality of plasma generation devices each including the coaxial cylindrical electrodes shown in FIG. 1.

### DETAILED DESCRIPTION OF THE PREFERRED EMBODIMENTS

The present invention will now be described in detail with reference to the accompanying drawings.

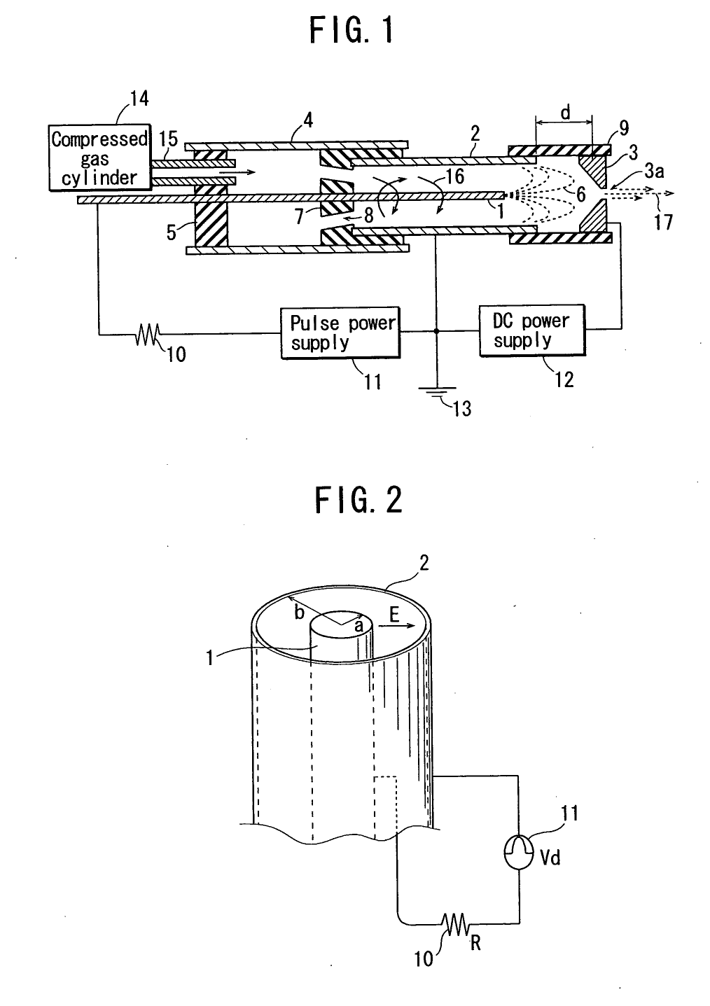

FIG. 1 is a sectional block diagram schematically showing the structure of a plasma generation device according to an embodiment of the present invention.

An example of an electrode bar 1 is a bar of 0.6 mm in diameter made of iridium alloy, tungsten, or stainless steel. An example of cylindrical electrode 2 is a cylindrical stainless steel pipe of 4.3 mm in internal diameter.

An example of a casing 4 is a cylindrical tube of 10 mm in internal diameter made of acryl or other resin, or stainless steel (SUS) or other metal if the casing 4 is insulated from the electrode.

A bottom member 5 is a disk member that fits inside the casing 4 and has holes therethrough for receiving the electrode bar 1 and a gas injection pipe 15. The bottom member 5 is made of an insulating material.

A support member 7 also fits inside the casing 4, as does the bottom member 5, and is formed such that the cylindrical electrode 2 can fit therein. The support member 7 has a plurality of through holes 8.

The holes 8 are slanted as shown in FIG. 1, so the working gas injected from the compressed gas cylinder 14 is formed into a spiral gas flow 16 through the holes 8 and moves forward in a spiral.

The support member 7 also has a hole therethrough for receiving the electrode bar 1. The support member 7 is also made of an insulating material.

The working gas from the compressed gas cylinder 14 is introduced through a gas injection pipe 15 into the casing 4. Although a compressed gas cylinder is used in this embodiment, the present invention is not limited to this embodiment and an air pump or the like may be used to inject air that is the working gas.

The electrode bar 1 penetrates the bottom member 5 and the support member 7 and is held in place by the bottom member 5 and the support member 7.

The cylindrical electrode 2 fits inside the support member 7 and is held in place, along with the electrode bar 1, by the support member 7. The electrode bar 1 is centered inside the cylindrical electrode 2, forming coaxial cylindrical electrodes.

In this embodiment, another support member 9 and an electrode plate 3 for accelerating plasma are also provided. One end of the cylindrical electrode 2 and the cylindrical electrode 2 fit inside the support member 9. The electrode plate 3 is made of stainless steel for example, and the support member 9 is made of an insulating material.

The electrode plate 3 has a hole 3a at its center through which an accelerated plasma 17 passes. This hole has a diameter of 2 mm or more, for example.

In this embodiment, the cylindrical electrode 2 is connected to a ground 13 and a pulse voltage from a pulse power supply 11 is applied through a resistor 10 (stabilizing resistor, protective resistor) to the electrode bar 1, so that a glow corona discharge or a spark discharge is induced between the electrode bar 1 and the cylindrical electrode 2. A high frequency power supply (inverter neon transformer) may be used instead of the pulse power supply.

The pulse power supply 11 may supply, for example, a pulse voltage having a half-sine waveform with a pulse width τ of 16 μsec at a frequency f of 0.7˜0.8 kHz, and a discharge voltage Vd of 2.5 kV. The discharge current Id may be 0.021 A, and the resistor 10 may have a resistance r of 140 kΩ.

When the working gas from the compressed gas cylinder 14 is introduced through the gas injection pipe 15 while an electrical discharge is taking place by the discharge voltage applied to a point between the electrode bar 1 and the cylindrical electrode 2, the spark discharge path 6 produced between the electrode bar 1 and the cylindrical electrode 2 is curved by the spiral gas flow 16 of the working gas formed through the holes 8 and jetted out of the nozzle, together with the working gas that is ionized into plasma while passing through the curved spark discharge path 6.

A DC voltage from the DC power supply 12 is applied to the electrode plate 3 which serves to draw electrons out of the plasma generated in the region of the spark discharge path 6. These electrons are jetted out of the hole 3a along with the squirting gas flow 16 from the compressed gas cylinder 14 and guided by the electrode plate 3 to form a plasma torch 17.

The plasma torch 17 can be used for roughening the surface of PP, for example, as described above.

In this embodiment, the distance d between the cylindrical electrode 2 and the electrode plate 3 shown in FIG. 1 may be determined as required as long as the spark discharge path 6 does not reach the electrode plate 3.

In this embodiment, a pulse voltage is applied between the electrode bar 1 and the cylindrical electrode 2 to prevent an arc discharge, and a stabilizing resistor 10 is inserted to cause a glow corona discharge or a spark discharge at atmospheric pressure. Specifically, a pulse power supply (or high frequency power supply (inverter neon transformer)) is used to prevent the arcing caused by a continuous discharge.

The effects of the coaxial cylindrical electrodes formed by the electrode bar 1 and the cylindrical electrode shown in FIG. 1 will now be described.

FIG. 2 illustrates the effects of the coaxial cylindrical electrodes of the plasma generation device shown in FIG. 1.

An electric field E produced between the electrode bar 1 and the cylindrical electrode 2 shown in FIG. 2 is represented by the equation (1):

$$E = \frac{Vd - RId}{log \frac{b}{r}} \cdot \frac{1}{r} \qquad ( 1 )$$

wherein, a represents the radius of electrode bar 1, b represents the internal radius of the cylindrical electrode 2, Vd represents the voltage of the pulse power supply 11, R represents the resistance of the resistor 10, Id represents the discharge current, and r represents the distance from the center.

Accordingly, the electric field is maximized when r=a, and the condition required for a glow corona discharge is given by the equation (2):

$$\frac{b}{a} > e \qquad ( 2 )$$

Consequently, in this embodiment, the radius a of the electrode bar 1 and the internal radius b of the cylindrical electrode 2 are preferably selected such that the relation indicated by the above equation is established. When the voltage is further increased under this condition, the glow corona discharge will change into a spark discharge.

Another embodiment of the present invention different from that shown in FIG. 1 will now be described.

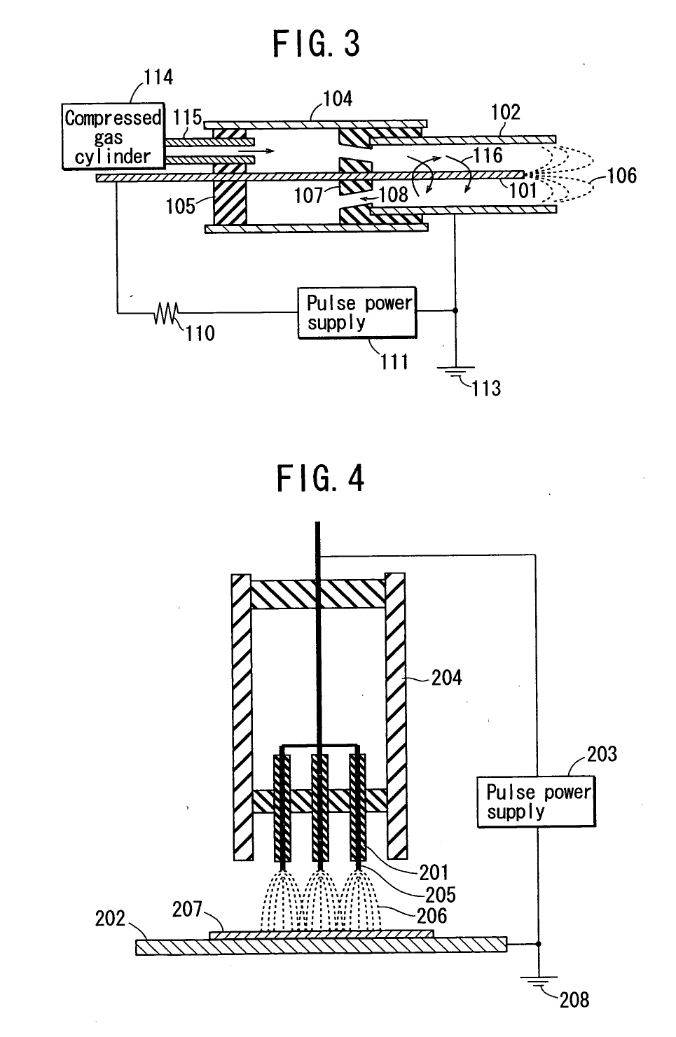

FIG. 3 is a sectional block diagram schematically showing the structure of a plasma generation device according to another embodiment of the present invention.

The plasma generation device of the embodiment shown in FIG. 3 does not have components corresponding to the electrode plate 3, support member 9, and DC power supply 12 of the plasma generation device shown in FIG. 1.

The structure of the plasma generation device shown in FIG. 3 will now be described.

An example of an electrode bar 101 is a bar of 0.6 mm in diameter made of iridium alloy, tungsten, or stainless steel. An example of cylindrical electrode 102 is a cylindrical stainless steel pipe of 4.3 mm in internal diameter.

An example of a casing 104 is a cylindrical tube of 10 mm in internal diameter made of stainless steel (SUS) or other metal, or acryl or other resin.

A bottom member 105 is a disk member that fits inside the casing 104 and has holes therethrough for receiving an electrode bar 101 and a gas injection pipe 115. The bottom member 105 is made of an insulating material.

The casing 104 also receives therein a support member 107 which in turn receives the cylindrical electrode 102 therein. The support member 107 has a plurality of through holes 108.

As shown in FIG. 3, the holes 108 are slanted such that the working gas from the compressed gas cylinder 114 is formed into a spiral gas flow 116 and moves forward in a spiral.

The support member 107 also has a hole therethrough for receiving the electrode bar 101. The support member 107 is also made of an insulating material.

The working gas from the compressed gas cylinder 114 is introduced thorough a gas injection pipe 115 into the casing 104.

The electrode bar 101 penetrates the bottom member 105 and the support member 107 and is held in place by the bottom member 105 and the support member 107.

On the other hand, the cylindrical electrode 102 fits inside the support member 107 which holds the electrode bar 101 and the cylindrical electrode 102 in place.

In this embodiment, unlike the embodiment in FIG. 1, one end of the cylindrical electrode 102 is exposed and the spark discharge path 106 is jetted outside forming a plasma torch. To roughen the surface of PP or another material as described above, the nozzle of the cylindrical electrode 102 is pointed at the target object such that the spark discharge path 106 touches the object.

The cylindrical electrode 102 is connected to a ground 113 and a pulse voltage from a pulse power supply 111 is applied through a resistor 110 (stabilizing resistor, protective resistor) to the electrode bar 101, so that a glow corona discharge or a spark discharge is induced between the electrode bar 101 and the cylindrical electrode 102.

When the working gas from the compressed gas cylinder 114 is introduced through the gas injection pipe 115 while an electrical discharge is taking place by the discharge voltage applied to a point between the electrode bar 101 and the cylindrical electrode 102, the spark discharge path 106 produced between the electrode bar 101 and the cylindrical electrode 102 is curved by the spiral gas flow 116 of the working gas formed through the holes 108 and jetted out of the nozzle, together with the working gas that is ionized into plasma while passing through the curved spark discharge path 106.

In this embodiment as well, a pulse voltage is applied between the electrode bar 101 and the cylindrical electrode 102 to prevent an arc discharge, and a resistor 110 functioning as a stabilizing resistor is inserted to cause a glow corona discharge or a spark discharge at atmospheric pressure.

Other features of this embodiment shown in FIG. 3 are the same as those of the embodiment shown in FIG. 1 and a further description is omitted.

A further embodiment of the present invention will now be described.

FIG. 4 is a sectional block diagram schematically showing the structure of a plasma generation device according to this embodiment.

The plasma generation device of the embodiment shown in FIG. 4 causes electrical discharges between a plurality of electrode bars and a plate electrode, without using the coaxial cylindrical electrodes shown in FIG. 1 and FIG. 3.

An example of an electrode bar 205 is a bar of 0.6˜1.0 mm in diameter made of iridium alloy, tungsten, or stainless steel. An example of electrode plate 202 is a plate made of aluminum foil or stainless steel.

An example of a casing 204 is a cylindrical tube of 12 mm in internal diameter made of acryl or other resin, or stainless steel (SUS) or other metal if the casing 4 is insulated from the electrodes.

The electrode bars 205 are covered by insulating tubes 201. Porcelain insulators may be used as the insulating tubes 201.

The electrode plate 202 is connected to a ground 208 and a pulse voltage from a pulse power supply 203 is applied to the electrode bars 205 to induce an electric discharge between the electrode bars 205 and the electrode plate 202. A high frequency power supply (inverter neon transformer) may be used instead of the pulse power supply.

The pulse power supply 203 may supply, for example, a pulse voltage with the discharge voltage Vd of 9.8 kV at the pulse frequency f of 2 kHz, and the distance between the electrode bars 205 and the electrode plate 202 may be in the range of 7˜10 mm. When such a discharge voltage is applied, a discharge path 206 is formed between the electrode bars 205 and the electrode plate 202 and plasma is generated.

An object 207 is placed on the electrode plate 202, with the surface to be roughened upward facing the electrode bar 205, as shown in FIG. 4.

When the pulses of high voltage from the pulse power supply 203 is applied to a point between the electrode bars 205 and the electrode plate 202 as described above, a glow discharge is induced between the electrodes and electric lines of force are concentrated near the electrode bars 205, building up an electric field of high intensity and thus generating plasma at a high density.

If the electrode bars 205 are positive, ions in the plasma are accelerated toward the electrode plate 202 and can sputter the object 207 on the electrode plate 202. The density of the generated plasma is controlled by the discharge current and the discharge interval is controlled by the discharge voltage.

Preferably, the applied voltage is high and the discharge current is low. Using a pulse power supply can prevent the arcing caused by a continuous discharge.

Advantageously, this embodiment does not require a pump or another mechanism for pumping the working gas into the plasma generation device to squirt the plasma forward as in the embodiments in FIG. 1 and FIG. 3.

This embodiment also facilitates simultaneous surface roughening over a wide area of the object 207 using a plurality of electrode bars 205.

It should be understood that, although a plurality of electrode bars are provided in FIG. 4, a single electrode bar may be used if simultaneous surface roughening over a wide area is not required.

Next, the spatial relationship between a plurality of electrode bars as disposed in FIG. 4 will be described.

FIGS. 5A and 5B are bottom views of the electrode bars of the plasma generation device in FIG. 3. FIG. 5A shows five electrode bars disposed close to each other, and FIG. 5B shows five electrode bars disposed apart from each other.

In FIGS. 5A and 5B, reference numerals 201a˜201e denote insulating tubes, 205a˜205e denote electrode bars, and 204 denotes a casing.

If the electrode bars 205a˜205e are disposed close to each other as shown in FIG. 5A, the electric discharge from the central electrode bar 205e may possibly be prevented. Electrons released from the central electrode bar 205e are deflected in the direction perpendicular to the electrode 205e, i.e., horizontal to the electrode plate 202, by the Lorentz force produced by the electric discharges from the surrounding electrode bars 205a˜205d. The electric field is also deflected in a similar direction and canceled out by the electric fields created in the opposite direction by the electrode bars 205a˜205e. Consequently, no electric discharge occurs, or the electric discharge is weakened, near the central electrode bar 205e, possibly resulting in a lower efficiency.

In this embodiment, the following arrangements are adopted to address this problem.

In a first arrangement, the electrode bars 205a˜205e are disposed apart from each other as shown in FIG. 5B.

This arrangement reduces the influence of the discharges from the electrode bars 205a˜205d on the electrons released from the electrode bar 205e and enables electric discharge from the central electrode bar 205e.

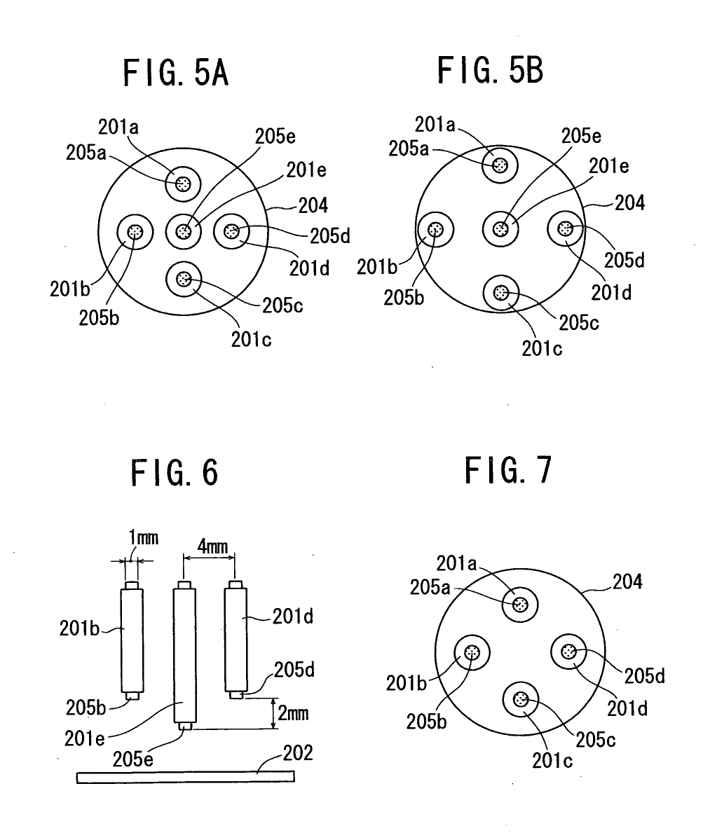

Another arrangement may be adopted as shown in FIG. 6.

FIG. 6 shows an arrangement different from that of FIG. 5B, for addressing the inefficiency due to no electric discharge from the central electrode bar.

Similar to FIG. 4, FIG. 6 is a side view of the plasma generation device having an electrode bar 205e disposed at the center and surrounded by electrode bars 205b and 205d. For simplicity, electrode bars 205a and 205c are omitted in FIG. 6.

In the arrangement shown in FIG. 6, the central electrode bar 205e is longer than the surrounding electrode bars 205a˜205d to avoid the influence of the discharges from the electrode bars 205a˜205d and enable electric discharge from the electrode bar 205e (for example, the central electrode bar is approximately 2 mm longer than the surrounding electrode bars when the electrodes are approximately 1 mm in diameter, and approximately 4 mm apart from each other).

A further arrangement will now be described with reference to FIG. 7.

FIG. 7 shows an arrangement different from those in FIG. 5B and FIG. 6, for addressing the inefficiency due to no electric discharge from the central electrode bar. Similar to FIG. 5B, FIG. 7 is a bottom view of the electrode bars of the plasma generation device shown in FIG. 3.

In the arrangement shown in FIG. 7, the problem that the central electrode does not effect electric discharge is totally solved by not providing the central electrode bar 205e in the first place.

An application example of the embodiment shown in FIG. 1 will now be described.

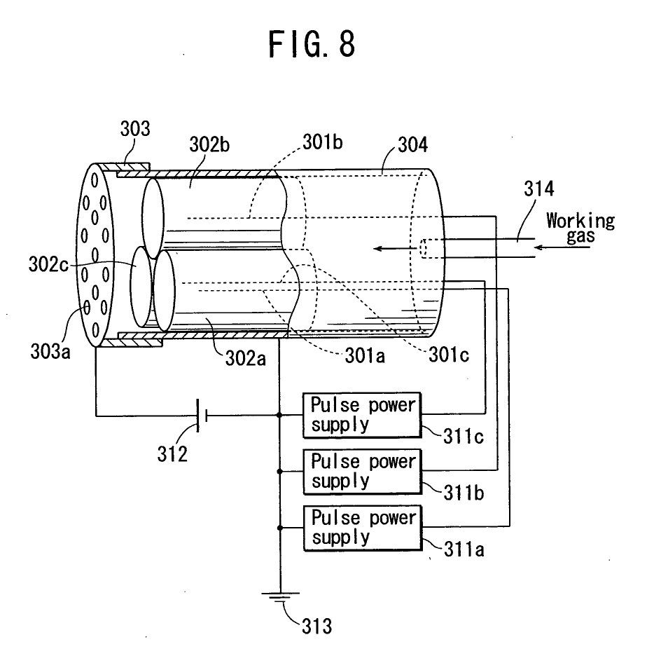

FIG. 8 is a sectional block diagram schematically showing a multiple-type plasma generation apparatus comprising a plurality of plasma generation devices each provided with the coaxial cylindrical electrodes shown in FIG. 1.

In FIG. 8, reference numerals 302a˜302c denote cylindrical electrodes, and reference numerals 301a˜301c denote electrode bars.

In the example shown in FIG. 8, a casing 304 houses three plasma generation devices comprising a cylindrical electrode 302a combined with an electrode bar 301a, cylindrical electrode 302b combined with an electrode bar 301b, and a cylindrical electrode 302c combined with an electrode bar 301c, respectively.

An electrode member 303 corresponding to the electrode plate 3 in FIG. 1, having holes 303a corresponding to the holes 3a in FIG. 1, is disposed at one end of the casing 304.

The cylindrical electrodes 302a˜302c are connected to a ground 313 and pulse voltages from pulsed power supplies 311a˜311c are applied to the electrode bars 301a˜301c, respectively. A positive voltage from a DC power supply 312 is applied to the electrode member 303.

Working gas is introduced through a gas injection pipe 314 into the casing 4 and plasma is generated by the three plasma generation devices comprising the cylindrical electrode 302a combined with electrode bar 301a, cylindrical electrode 302b combined with electrode bar 301b, and cylindrical electrode 302c combined with electrode bar 301c, respectively, is drawn out by the electrode member 303 and jetted out of holes 303a to form a plasma torch.

Such a multiple-type plasma generation apparatus can generate a large amount of plasma without the need to increase the discharge voltage.

As described above, the plasma generated by the plasma generation devices according to the present invention can be used to modify the surface of an object. For example, the plasma can be used to roughen a PP surface to make it suitable for printing, or roughen the surface of an object to improve its adhesiveness when an adhesive is applied for bonding.

1. A plasma generation device comprising a first electrode, a second electrode, and a pulse power supply for generating a pulse voltage, wherein plasma is generated by an electric discharge induced between said first electrode and said second electrode by applying a predetermined pulse voltage from said pulse power supply to a point between said first electrode and said second electrode.

2. A plasma generation device comprising a first electrode, a second electrode, and a high frequency power supply for generating a high frequency voltage, wherein plasma is generated by an electric discharge induced by applying a predetermined high frequency voltage from said high frequency power supply to a point between said first electrode and said second electrode.

3. The plasma generation device according to claim 1, wherein said first electrode is an electrode bar and said second electrode is a cylindrical electrode, and said electrode bar is disposed at the center of said cylindrical electrode, forming coaxial cylindrical electrodes.

4. The plasma generation device according to claim 1, further comprising a third electrode plate for directing said plasma to a desired jetting direction.

5. A multiple-type plasma generation apparatus comprising a plurality of plasma generation devices according to claim 3.

6. The plasma generation device according to claim 1, wherein said first electrode is an electrode bar and said second electrode is an electrode plate, wherein one end of said electrode bar is disposed facing a surface of said electrode plate, with a predetermined distance therebetween.

7. The plasma generation device according to claim 6, comprising a plurality of said electrode bars.

8. The plasma generation device according to claim 7, wherein said plurality of electrode bars are disposed apart with a predetermined distance therebetween.

9. The plasma generation device according to claim 7, wherein said plurality of electrode bars are disposed such that a central electrode bar is closer to said electrode plate than the other electrode bars.

10. The plasma generation device according to claim 7, wherein said plurality of electrode bars are disposed such that none of the electrode bars are disposed at the center.

11. The plasma generation device according to claim 1, said first electrode being made of iridium alloy.

12. The plasma generation device according to claim 1, said first electrode being made of tungsten.
